(19) United States
(12) Patent Application Publication
(10) Pub. No.: US 2018/0075821 A1
(43) Pub. Date: Mar. 15, 2018

(54) PROJECTOR AND METHOD OF CONTROLLING PROJECTOR

(71) Applicant: SEIKO EPSON CORPORATION, Tokyo (JP)

(72) Inventor: Takahiro ANO, Matsumoto-shi (JP)

(73) Assignee: SEIKO EPSON CORPORATION, Tokyo (JP)

(21) Appl. No.: 15/560,380

(22) PCT Filed: Mar. 18, 2016
(86) PCT No.: PCT/JP2016/001602

§ 371 Date: Sep. 21, 2017

(30) Foreign Application Priority Data
Mar. 30, 2015 (JP) 2015-068094

(51) Int. Cl. G09G 5/38; H04N 9/31; G06F 3/041

(52) U.S. Cl. CPC G09G 5/38; H04N 9/3185; G09G 2320/08; H04N 9/3194; G06F 3/041

(57) ABSTRACT

A projector projecting a projection image to a projection surface is configured to perform a process corresponding to non-constancy of the size of a region to which the projection image is projected. A projector includes: a projection unit that projects a projection image including an object image to a screen SC; a projection size measurement unit that measures a size of a region to which the projection image is projected; a detection unit that detects an operation of an indicator on the screen SC; and a movement amount adjustment unit that causes a movement amount of the object image to differ in accordance with the size of the image projection region in a case in which the operation of the indicator S detected by the detection unit is an operation of moving the object image.

### TECHNICAL FIELD

The present invention relates to a projector and a method of controlling the projector.

### Background Art

In the related art, in apparatuses displaying images (display control apparatuses), there are known technologies for moving displayed images on screens through user operations such as scroll (for example, see PTL 1).

In recent years, projectors projecting objects such as graphical user interfaces (GUIs) to projection surfaces such as screens have been widespread. In addition, the sizes of regions to which projection images including objects are projected by the projectors (regions to which projection images can be projected (regions in which pixels can be formed)) vary due to separate distances between projectors and projection surfaces, setting of projection optical systems of the projectors, or the like, and thus are not constant.

### CITATION LIST

### Patent Literature

PTL 1: JP-A-2014-59602

### SUMMARY OF INVENTION

### Technical Problem

Here, it is assumed that an object projected to a projection surface by a projector is moved on the projection surface through a user operation as in the technology disclosed in PTL 1. In this case, when an object can be moved in a mode corresponding to the size of a region to which a projection image is projected based on the fact that the size of the region to which the projection image is projected by the projector is not constant, convenience for a user is improved. However, there is no projector capable of performing a process corresponding to non-constancy of the size of a region to which a projection image is projected by such a projector.

The invention is devised in view of the above-described circumstances and an object of the invention is to provide a projector that projects a projection image to a projection surface and is capable of performing a process corresponding to non-constancy of the size of a region to which the projection image is projected.

### Solution to Problem

To achieve the foregoing object, according to an aspect of the invention, there is provided a projector including: a projection unit that projects a projection image including a first object to a projection surface; a projection size measurement unit that measures a size of a region to which the projection image is projected; a detection unit that detects an operation of an indicator on the projection surface; and a movement amount adjustment unit that causes a movement amount of the first object to differ in accordance with the size of the region to which the projection image is projected in a case in which the operation of the indicator detected by the detection unit is an operation of moving the first object.

In the configuration according to the aspect of the invention, to correspond to non-constancy of the size of the region to which the projection image is projected, the projector can set a movement amount at the time of moving the position of the first object based on an operation of moving the first object as a value corresponding to the size of the region.

In the projector according to the aspect of the invention, of a first movement amount of the first object when a first operation of moving the first object is performed in a case in which the size of the region to which the projection image is projected is a first size and a second movement amount of the first object when the first operation is performed in a case in which the size of the region to which the projection image is projected is a second size larger than the first size, the movement amount adjustment unit causes the second movement amount to be larger.

In the configuration according to the aspect of the invention, as the size of the region to which the projection image is projected is larger, the movement amount of the first object at the time of operating the same indicator can be larger. Thus, it is easy for the operator (the user) to perform a work at the time of moving the first object.

In the projector according to the aspect of the invention, the movement amount adjustment unit causes the movement amount of the first object to be larger in a case in which the same operation of the indicator is performed as the size of the region to which the projection image is projected is larger.

In the configuration according to the aspect of the invention, as the size of the region to which the projection image is projected is larger, the movement amount of the first object at the time of operating the same indicator can be larger. Thus, it is easy for the operator (the user) to perform a work at the time of moving the first object.

In the projector according to the aspect of the invention, the operation of moving the first object is an operation continuously transitioning from a state in which the indicator comes into contact with the projection surface and moves to a state in which the indicator moves contactlessly. The movement amount adjustment unit calculates the movement amount of the first object by multiplying a movement distance of the indicator after the transition of the indicator to the contactless state to the projection surface by a coefficient according to the size of the region to which the projection image is projected.

In the configuration according to the aspect of the invention, an operation performed intentionally with an intention to move the first object by the operator can be determined as an operation of moving the first object. The movement amount adjustment unit can set the value of the movement amount as an appropriate value according to the size of the image projection region using a movement amount coefficient.

The projector according to the aspect of the invention further includes a photographing unit that photographs the projection surface. The projection size measurement unit causes the projection unit to project a specific pattern image to the projection surface, causes the photographing unit to photograph the projection surface to which the pattern image is projected, and measures the size of the region to which the projection image is projected based on a photographing result by the photographing unit.

In the configuration according to the aspect of the invention, a work of the user is not necessary and convenience for the user is improved in the measurement of the size of the region to which the projection image is projected.

To achieve the foregoing object, according to an aspect of the invention, there is provided a method of controlling a projector including a projection unit that projects a projection image including a first object to a projection surface. The method includes: measuring a size of a region to which the projection image is projected; detecting an operation of an indicator on the projection surface; and causing a movement amount of the first object to differ in accordance with the size of the region to which the projection image is projected in a case in which the detected operation of the indicator is an operation of moving the first object.

### BRIEF DESCRIPTION OF DRAWINGS

FIG. 1 is a diagram illustrating a use mode of a projector.

FIG. 2 is a functional block diagram illustrating a projector and a first indicator.

FIG. 3 is a flowchart illustrating an operation of the projector.

FIG. 4 is a diagram illustrating a movement gesture.

FIG. 5 is a diagram illustrating a movement amount.

### DESCRIPTION OF EMBODIMENTS

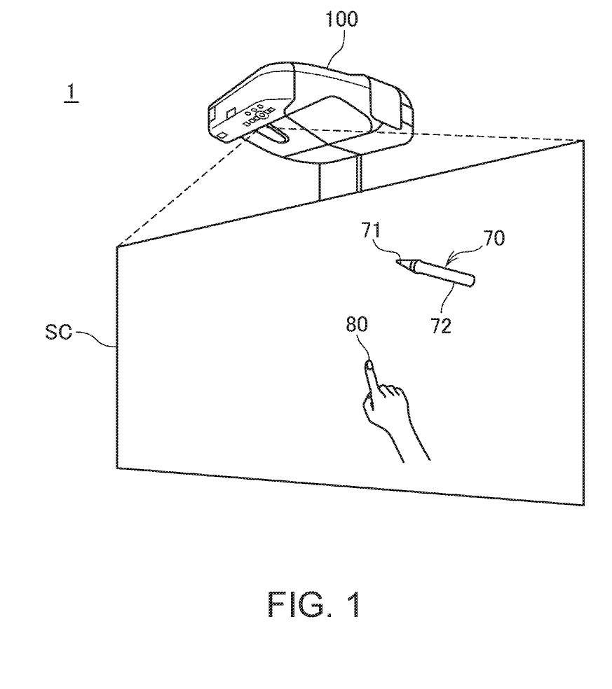

FIG. 1 is a diagram illustrating an installation state of a projector 100.

The projector 100 is installed immediately above or obliquely above a screen SC (projection surface) and projects an image (projection image) toward the screen SC obliquely below the projector 100. The screen SC is a plate or a curtain fixed to a wall surface or erect to a surface of a floor. The invention is not limited to this example and the wall surface can also be used as the screen SC. In this case, the projector 100 maybe mounted on an upper portion of the wall surface used as the screen SC.

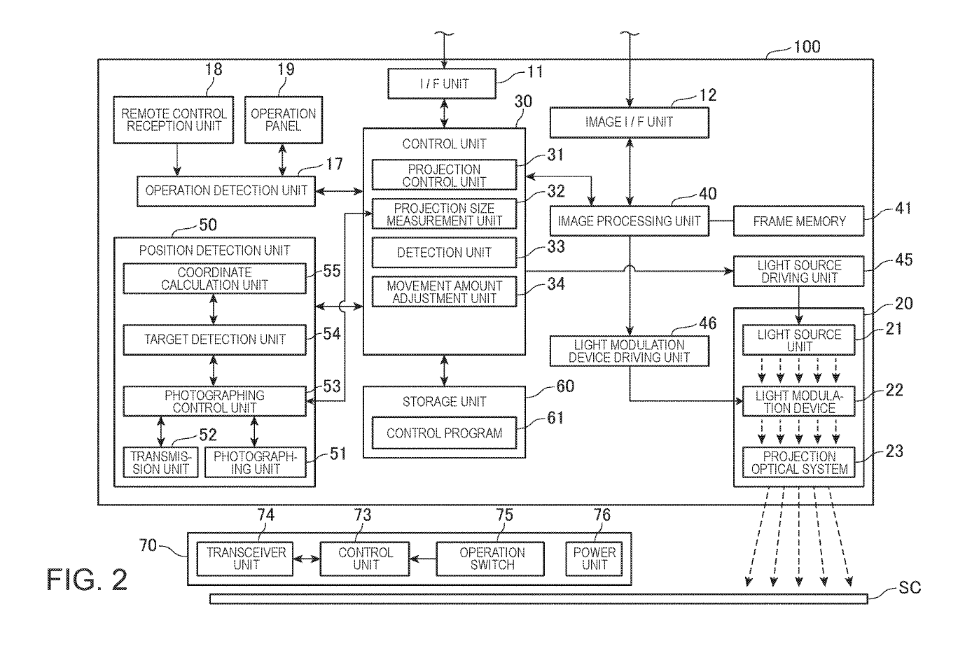

The projector 100 is connected to an image supply apparatus such as a personal computer (PC), a video reproduction apparatus, a DVD reproduction apparatus, a Blu-ray (registered trademark) Disc (Blu-ray disc) reproduction apparatus. The projector 100 projects an image to the screen SC based on an analog image signal or a digital image data supplied from the image supply apparatus. The projector 100 may read image data stored in an internal storage unit 60 (see FIG. 2) or an externally connected storage medium and may display an image on the screen SC based on the image data.

The projector 100 detects an operation on the screen SC by an operator. In the operation on the screen SC, a pen-type first indicator 70 or a second indicator 80 which is a finger of the operator is used.

The operation on the screen SC includes an operation of designating (instructing) a certain position on the screen SC with the first indicator 70 or the second indicator 80 and an operation of continuously instructing another position on the screen SC.

The operation of designating (instructing) a certain position on the screen SC is an operation of bringing the first indicator 70 or the second indicator 80 into contact with a certain position on the screen SC.

The operation of continuously instructing another position on the screen SC is an operation of moving the first indicator 70 or the second indicator 80 while bringing the first indicator 70 or the second indicator 80 into contact with the screen SC and drawing text, a figure, or the like.

The projector 100 detects an operation performed by the operator using the first indicator 70 or the second indicator 80 and reflecting the detected operation in a projection image on the screen SC. Further, the projector 100 may operate as a pointing device by detecting an instructed position and outputs the coordinates of the instructed position on the screen SC. The coordinates can be used to also perform a graphical user interface (GUI) operation on the projector 100.

FIG. 2 is a diagram illustrating a configuration of the projector 100.

The projector 100 includes an interface (I/F) unit 11 and an image interface (I/F) unit 12 as interfaces connected to external apparatuses. The I/F unit 11 and the image I/F unit 12 may include connectors for wired connection and include interface circuits corresponding to the connectors. The I/F unit 11 and the image I/F unit 12 may include wireless communication interfaces. Examples of the connectors for wired connection and the interface circuits include connectors and interface circuits conforming to a wired LAN, IEEE 1394, and a USB. Examples of the wireless communication interfaces include interfaces conforming to a wireless LAN and Bluetooth (registered trademark). An interface for image data such as HDMI (registered trademark) interface can be used in the image I/F unit 12. The image I/F unit 12 may include an interface to which audio data is input.

The I/F unit 11 is an interface that transmits and receives various kinds of data to and from an external apparatus such as a PC. The I/F unit 11 inputs and outputs data for projection of an image, data for setting an operation of the projector 100, and the like. The control unit 30 to be described below has a function of transmitting and receiving data to and from an external apparatus via the I/F unit 11.

The image I/F unit 12 is an interface to which digital image data is input. The projector 100 according to the embodiment projects an image based on the digital image data input via the image I/F unit 12. The projector 100 may have a function of projecting an image based on an analog image signal. In this case, the image I/F unit 12 may include an interface for an analog image and an A/D conversion circuit that converts an analog image signal into digital image data.

The projector 100 includes a projection unit 20 that forms an optical image. The projection unit 20 includes a light source unit 21, a light modulation device 22, and a projection optical system 23. The light source unit 21 includes a light source formed of a xenon lamp, an ultra-high pressure mercury lamp, a light emitting diode (LED), or a laser light source. The light source unit 21 may include a reflector and an auxiliary reflector that guide light emitted by the light source to the light modulation device 22. Further, the projector 100 may include a lens group (not illustrated) for improving optical characteristics of projected light, a polarizing plate, or a modulated light element that reduces an amount of light emitted by the light source along a route reaching the light modulation device 22.

The light modulation device 22 includes three transmissive liquid crystal panels corresponding to the three primary colors of RGB and modulates light transmitted through the liquid crystal panels to generate image light. Light from the light source unit 21 is separated into three pieces of color light of RGB and the pieces of color light are incident on the corresponding liquid crystal panels, respectively. The pieces of color light that pass through the liquid crystal panels and that are modulated are combined by a combination optical system such as a cross dichroic prism to exit to the projection optical system 23.

The projection optical system 23 includes a lens group that guides the image light modulated by the light modulation device 22 in the direction of the screen SC and forms an image on the screen SC. The projection optical system 23 may include a zoom mechanism that expands or reduces a display image on the screen SC and adjusts a focus or a focus adjustment mechanism that adjusts a focus. In a case in which the projector 100 is of a short focus type, a concave mirror that reflects the image light toward the screen SC may be included in the projection optical system 23.

The projection unit 20 is connected to a light source driving unit 45 that turns on the light source unit 21 under the control of the control unit 30 and a light modulation device driving unit 46 that operates the light modulation device 22 under the control of the control unit 30. The light source driving unit 45 may have a function of adjusting an amount of light of the light source unit 21 by switching turning on and turning off the light source unit 21.

The projector 100 includes an image processing system that processes an image to be projected by the projection unit 20. The image processing system includes the control unit 30 that controls the projector 100, the storage unit 60, an operation detection unit 17, an image processing unit 40, the light source driving unit 45, and the light modulation device driving unit 46. A frame memory 41 is connected to the image processing unit 40 and a position detection unit 50 is connected to the control unit 30. These units may be included in the image processing system.

The control unit 30 controls each unit of the projector 100 by executing a predetermined control program 61.

The storage unit 60 stores not only the control program 61 executed by the control unit 30 but also data to be processed by the control unit 30 and other data in a nonvolatile manner.

The image processing unit 40 processes the image data input via the image I/F unit 12 under the control of the control unit 30 and outputs an image signal to the light modulation device driving unit 46. Processes performed by the image processing unit 40 are a process of discriminating a 3D (stereoscopic) image from a 2D (planar) image, a resolution conversion process, a frame rate conversion process, a distortion correction process, a digital zoom process, a color tone correction process, and a luminance correction process. The image processing unit 40 performs a process designated by the control unit 30 and performs a process using a parameter input from the control unit 30, as necessary. A plurality of processes among the foregoing processes can also be combined to be performed, of course.

The image processing unit 40 is connected to the frame memory 41. The image processing unit 40 loads the image data input from the image input I/F 12 on the frame memory 41 and performs the various processes on the loaded image data. The image processing unit 40 reads the processed image data from the frame memory 41, generates image signals of R, G, and B corresponding to the image data, and outputs the image signals to the light modulation device driving unit 46.

The light modulation device driving unit 46 is connected to the liquid crystal panels of the light modulation device 22. The light modulation device driving unit 46 drives the liquid crystal panels based on the image signals input from the image processing unit 40 and draws an image on each liquid crystal panel.

The operation detection unit 17 is connected to a remote control light reception unit 18 and an operation panel 19 functioning as input devices and detects an operation via the remote control light reception unit 18 and the operation panel 19.

The remote control light reception unit 18 receives an infrared signal transmitted in response to a button operation by a remote controller (not illustrated) used by the operator of the projector 100. The remote control light reception unit decodes the infrared signal received from the remote controller, generates operation data indicating operation content in the remote controller (remote control), and outputs the operation data to the control unit 30.

The operation panel 19 is installed on an exterior casing of the projector 100 and includes various switches and indicator lamps. The operation detection unit 17 appropriately turns on and off the indicator lamps of the operation panel 19 according to an operation state or a setting state of the projector 100 under the control of the control unit 30. When a switch of the operation panel 19 is operated, operation data corresponding to the operated switch is output from the operation detection unit 17 to the control unit 30.

The position detection unit 50 detects an instruction position with at least one of the first indicator 70 and the second indicator 80. The position detection unit 50 includes units, that is, a photographing unit 51, a transmission unit 52, a photographing control unit 53, a target detection unit 54, and a coordinate calculation unit 55.

The photographing unit 51 forms a photographic image obtained by photographing a range including the screen SC and its periphery as a photographic range. The photographing unit can perform photographing with infrared light and photographing with the visible light. Specifically, the photographing unit 51 can be configured to include an infrared image sensor photographing infrared light, a visible light image sensor photographing the visible light, an interface circuit of the infrared image sensor, and an interface circuit of the visible light image sensor. One image sensor may be configured to photograph the visible light and infrared light. For example, the photographing unit 51 may include a filter that blocks a part of light incident on an image sensor. In a case in which infrared light is received by the image sensor, a filter that mainly transmits light an infrared region may be disposed before the image sensor. As the image sensor, any of a CCD and a CMOS can be used or another element can also be used.

A photographic direction and a photographic range (angle of view) of the photographing unit 51 at the time of photographing with infrared light covers a range in which the projection optical system 23 projects an image onto the screen SC in the same direction or substantially the same direction as the projection optical system 23. Similarly, a photographic direction and a photographic range of the photographing unit 51 at the time of photographing with the visible light covers a range in which the projection optical system 23 projects an image onto the screen SC in the same direction or substantially the same direction as the projection optical system 23. The photographing unit 51 outputs data of a photographic image photographed with infrared light and data of a photographic image photographed with the visible light.

The photographing control unit 53 controls the photographing unit 51 such that the photographing unit 51 performs photographing under the control of the control unit 30. The photographing control unit 53 acquires the photographic image data of the photographing unit 51 and outputs the photographic image data to the target detection unit 54.

Hereinafter, the data of a photographic image photographed with the visible light by the photographing unit 51 is referred to as “visible-light photographic image data” and the data of a photographic image photographed with infrared light by the photographing unit 51 is referred to as “infrared-light photographic image data”.

In a case in which there is the first indicator 70 in the photographic range, the first indicator 70 is shown in the visible-light photographic image data. In a case in which there is a finger of an operator which is the second indicator 80 in the photographic range, the second indicator 80 is shown in the visible-light photographic image data.

An image of infrared light emitted by the first indicator 70 is shown in the infrared-light photographic image data.

The transmission unit 52 transmits an infrared signal to the first indicator 70 under the control of the photographing control unit 53. The transmission unit 52 includes a light source such as an infrared LED. The light source is turned on and off under the control of the photographing control unit 53.

The target detection unit 54 detects an image of a finger of the operator from the visible-light photographic image data and detects the second indicator 80.

For example, the target detection unit 54 detects the second indicator 80 according to the following method. That is, the target detection unit 54 detects a person region in which a person is shown from the visible-light photographic image data. The person region is a region that contains an image of a person in a photographic image. In detection of a person region by the target detection unit 54, a generally known method can be used. For example, the target detection unit 54 detects the edge of the input visible-light photographic image data and detects a region matching a shape of a person as a person region. The target detection unit 54 may detect a region in which color information (luminance, chromaticity, or the like) is changed within a predetermined time and may detect the detected region of which a size is equal to or larger than a predetermined value or the detected region of which a sequential movement range is within a predetermined range, as a person region. Subsequently, the target detection unit 54 detects a region close to a pre-decided shape or property of a finger from the detected person region as a region of the second indicator 80. The finger of the operator detected by the target detection unit 54 may be any of one finger, a plurality of fingers, a whole hand, or apart of a hand including fingers.

The target detection unit 54 specifies a front end (fingertip) of a finger from the detected region of the second indicator 80 and detects the position of the specified front end of the finger as an instruction position. The target detection unit 54 calculates the coordinates of the instruction position of the second indicator 80 with coordinates in data of the photographic image.

The target detection unit 54 detects a distance between the screen SC and the detected instruction position of the second indicator 80. The target detection unit 54 determines a distance between the screen SC and the detected front end (the instruction position) of the finger based on the visible-light photographic image data. For example, the target detection unit 54 detects an image of the finger from the data of the photographic image and an image of the shadow of the finger and obtains the distance between the screen SC and the front end of the finger based on a distance from the detected image.

A method of detecting the distance between the screen SC and the instruction position of the second indicator 80 is not limited to the exemplified method. For example, there is provided another photographing unit that photographs a predetermined range from the surface of the screen SC with the visible light at an optical axis parallel to the surface of the screen SC. Then, data of a photographic image based on a photographing result of the other photographing unit is output to the target detection unit 54. The target detection unit 54 detects the position of the front end of a finger as an instruction position from the input data of the photographic image according to the above-described same method and obtains a distance between the screen SC and the instruction position (the front end of the finger) based on a separation amount between the instruction position detected in the data of the photographic image and an image corresponding to the surface of the screen SC.

The target detection unit 54 detects the coordinates of an instruction position of the first indicator 70 based on the infrared-light photographic image data. The target detection unit 54 detects an image of the infrared light shown in the data of the photographic image photographed with the infrared light by the photographing unit 51 and detects the coordinates of the instruction position of the first indicator 70 in the data of the photographic image. The details of a method of specifying the first indicator 70 from the data of the photographic image by the photographing unit 51 will be described below.

The target detection unit 54 determines whether a front end portion 71 of the first indicator 70 comes into contact with the screen SC and generates touch information indicating whether the front end portion 71 comes into contact with the screen SC. A method of determining whether the front end portion 71 of the first indicator 70 comes into contact with the screen SC will be also described below.

The target detection unit 54 detects the distance between the screen SC and the front end portion 71 (instruction position) of the first indicator 70. For example, the target detection unit 54 detects an image of the first indicator 70 and an image of the shadow of the first indicator 70 from the visible-light photographic image data and obtains a distance between the screen SC and the front end of a finger based on a distance between the detected images, as in the method exemplified in the calculation of the distance between the screen SC and the instruction position of the second indicator 80. For example, the target detection unit 54 obtains a distance between the screen SC and the instruction position of the first indicator 70 based on data of the photographic image input from another photographing unit that images a predetermined range from the surface of the screen SC with the visible light at an optical axis parallel to the surface of the screen SC, as in the method exemplified in the calculation of the distance between the screen SC and the instruction position of the second indicator 80.

The coordinate calculation unit 55 converts the coordinates of the instruction position into coordinates of the instruction position in a display image on the screen SC. The coordinates of the instruction positions of the first indicator 70 and the second indicator 80 detected by the target detection unit 54 are coordinates in the data of the photographic image. The coordinate calculation unit 55 calculates the coordinates of the instruction position at a coordinate axis virtually installed on the display image on the screen SC from the coordinates of the instruction position detected by the target detection unit 54 based on a result of calibration. The coordinates in the data of the photographic image are affected by various factors such as a distance between the projector 100 and the screen SC, a zoom magnification in the projection optical system 23, an installation angle of the projector 100, and a distance between the photographing unit 51 and the screen SC. The coordinate calculation unit 55 calculates the coordinates of the instruction position in the display image on the screen SC from the coordinates of the instruction position in the data of the photographic image based on a result of calibration performed in advance. In the calibration, a predetermined pattern image is projected from the projection unit 20 to the screen SC and the displayed pattern image is photographed by the photographing unit 51. Based on the pattern image photographed by the photographing unit 51, a correspondence relation (coordinate conversion parameter) between the coordinates in the data of the photographic image and the coordinates in the display image on the screen SC is derived.

In regard to the second indicator 80, the coordinate calculation unit 55 outputs the coordinates of the instruction position of the second indicator 80 and information indicating the distance between the screen SC and the instruction position of the second indicator 80 detected by the target detection unit 54 (hereinafter referred to as “second separation distance information”) to the control unit 30.

In regard to the first indicator 70, the coordinate calculation unit 55 outputs the coordinates of the instruction position of the first indicator 70, information indicating the distance between the screen SC and the instruction position of the second indicator 80 detected by the target detection unit 54 (hereinafter referred to as “first separation distance information”), and touch information to the control unit 30.

The first indicator 70 includes a control unit 73, a transceiver unit 74, an operation switch 75, and a power unit 76. These units are accommodated in the shaft portion 72 (see FIG. 1). The control unit 73 is connected to the transceiver unit 74 and the operation switch 75 and detects an ON/OFF state of the operation switch 75. The transceiver unit 74 includes a light source such as an infrared LED and a light reception element that receives infrared light, turns on and off the light source under the control of unit 73, and outputs a signal indicating a light reception state of the light reception element to the control unit 73.

The operation switch 75 is a switch of which ON/OFF is switched depending on whether the front end portion 71 of the first indicator 70 comes into contact.

The power unit 76 includes a battery or a secondary cell as a power source and supplies power to the units, that is, the control unit 73, the transceiver unit 74, and the operation switch 75. The first indicator 70 may include a power switch that turns on/off power supply from the power unit 76.

Here, a method of specifying an instruction position of the first indicator 70 from infrared-light photographic image data of the photographing unit 51 through mutual communication of the position detection unit 50 and the first indicator 70 will be described.

In a case in which an operation is detected with the first indicator 70, the control unit 30 controls the photographing control unit 53 and causes the transmission unit 52 to transmit a synchronization signal. That is, the photographing control unit 53 turns on the light source of the transmission unit 52 at a predetermined period under the control of the control unit 30.

On the other hand, the control unit 73 starts supplying power from the power unit 76 and performs a predetermined initialization operation, and subsequently causes the transceiver unit 74 to receive the infrared light emitted by the transmission unit 52 of the projector 100. When the transceiver unit 74 receives the infrared light periodically emitted by the transmission unit 52, the control unit 73 causes the preset first indicator 70 to turn on (emits light) the light source of the transceiver unit 74 in a unique lighting pattern in synchronization with a timing of the infrared light. The control unit 73 switches a lighting pattern of the transceiver unit 74 according to an operation state of the operation switch 75. Therefore, the target detection unit 54 of the projector 100 can determine an operation state of the first indicator 70, that is, whether the front end portion 71 is pressed against the screen SC, based on a plurality of pieces of photographic image data.

The control unit 73 repeatedly performs the foregoing pattern while power is supplied from the power unit 76. That is, the transmission unit 52 periodically transmits the synchronization infrared signal to the first indicator 70. The first indicator 70 transmits a preset infrared signal in synchronization with the infrared signal transmitted by the transmission unit 52.

The photographing control unit 53 performs control such that a photographic timing by the photographing unit 51 matches a timing at which the first indicator 70 is turned on. The photographic timing is decided based on a timing at which the photographing control unit 53 turns on the transmission unit 52. The target detection unit 54 can specify a pattern in which the first indicator 70 is turned on according to whether the image of the light of the first indicator 70 is shown in the photographic image data of the photographing unit 51. The target detection unit 54 determines whether the front end portion 71 of the first indicator 70 is pressed against the screen SC based on the plurality of pieces of photographic image data and generates touch information.

The lighting pattern of the first indicator 70 can include a pattern unique for each entity of the first indicator 70 or a common pattern to the plurality of first indicators 70 and a pattern unique to each entity. In this case, the target detection unit 54 can distinguish each image as images of the different first indicators 70 in a case in which the image of the infrared light emitted by the plurality of first indicators 70 is included in the photographic image data.

The control unit 30 realizes functions of a projection control unit 31, a projection size measurement unit 32, a detection unit 33, and a movement amount adjustment unit 34 by reading and executing the control program 61 stored in the storage unit 60, and controls each unit of the projector 100.

The projection control unit 31 acquires operation content formed through an operation by an operator on the remote controller based on the operation data input from the operation detection unit 17. The projection control unit 31 controls the image processing unit 40, the light source driving unit 45, the light modulation device driving unit 46 according to an operation performed by the operator and projects an image onto the screen SC.

The projection control unit 31 controls the image processing unit 40 such that the image processing unit 40 performs the process of discriminating a 3D (stereoscopic) image from a 2D (planar) image, the resolution conversion process, the frame rate conversion process, the distortion correction process, the digital zoom process, the color tone correction process, and the luminance correction process described above. The projection control unit 31 controls the light source driving unit 45 in conformity to the process of the image processing unit 40 to control the amount of light of the light source unit 21.

The projection size measurement unit 32 measures the size of the image projection region which is a region to which an image can be projected to the screen SC by the projector 100 (a region in which pixels can be formed) by performing the following process at the time of supplying power to the projector 100 or in calibration performed according to an instruction from a user. The size of the image projection region is equivalent to “a size of a region to which a projection image is projected”.

That is, in the calibration, the projection size measurement unit 32 acquires image data (hereinafter referred to as “specific pattern image data”) of a specific pattern image (hereinafter referred to as a “specific pattern image”). The specific pattern image data is stored in advance in a predetermined storage region of the storage unit 60. Subsequently, the projection size measurement unit 32 controls the image processing unit 40 based on the acquired specific pattern image data and controls the light source driving unit 45, the light modulation device driving unit 46, and other mechanisms to project the specific pattern image to the screen SC.

The specific pattern image is, for example, an image that includes images with a predetermined shape indicating four corners in the four corners of a maximum region (a region corresponding to the image projection region) in which pixels can be formed.

Subsequently, the projection size measurement unit 32 controls the photographing unit 51 by controlling the photographing control unit 53 such that the photographing unit 51 photographs the screen SC. The photographic image data based on a photographing result of the photographing unit 51 is output from the photographing control unit 53 to the projection size measurement unit 32. The projection size measurement unit 32 analyzes the photographic image data input from the photographing control unit 53 and measures the size of the image projection region according to, for example, the following method. That is, the projection size measurement unit 32 specifies data of the images shown in the four corners in the photographic image data according to a method such as pattern matching. Subsequently, the projection size measurement unit 32 measures a separation distance in the photographic image data between the data of two images in two corners separated in the vertical direction among the data of the images in the four corners. Here, the separation distance of the data of the images in the two corners separated vertically in the image data has a proportional relation with a separation distance (=a length of the image projection region in the vertical direction) of the images in two corners corresponding in the specific pattern image projected to the screen SC. Based on this, the projection size measurement unit 32 adds image processing such as trapezoid correction performed at the time of projecting the specific pattern image or setting regarding the projection optical system 23 such as a zoom magnification in the projection optical system 23, and then measures the length of the image projection region in the vertical direction based on the measured separation distance. According to the same method, the projection size measurement unit 32 measures a length of the image projection region in the horizontal direction based on a separation distance in the photographic image data between the data of the images in two corners separated in the horizontal direction. A combination of the lengths of the image projection region detected in this way in the vertical direction and the horizontal direction is equivalent to the size of the image projection region.

The length of the image projection region in the vertical direction and the length of the image projection region in the horizontal direction mean physical lengths represented in predetermined units.

In regard to the second indicator 80, the detection unit 33 acquires the coordinates of the instruction position of the second indicator 80 output by the coordinate calculation unit 55 and second separation distance information (information indicating the distance between the screen SC and the instruction position of the second indicator 80). In a case in which a predetermined operation is performed with the second indicator 80, the detection unit 33 detects that the predetermined operation is performed based on the acquired information. For example, in a case in which a GUI including an icon for instructing that a predetermined process is performed is operated with the second indicator 80, the detection unit 33 detects the predetermined process based on the acquired information.

In regard to the first indicator 70, the detection unit 33 acquires the coordinates of the instruction position of the first indicator 70 output from the coordinate calculation unit 55, first separation distance information (information indicating the distance between the screen SC and the instruction position of the second indicator 80), and touch information. In a case in which a predetermined operation is performed with the first indicator 70, the detection unit 33 detects that the predetermined operation is performed based on the acquired information. For example, in a case in which a GUI including an icon for instructing that a predetermined process is performed is operated with the first indicator 70, the detection unit 33 detects the predetermined process based on the acquired information.

Further, in a case in which a predetermined gesture for instructing movement of an object image (first object) on the screen SC (hereinafter referred to as a “movement gesture”) is performed with the first indicator 70 or the second indicator 80, the detection unit 33 detects the predetermined gesture.

The object image, a mode of the movement gesture, and a method of detecting the movement gesture will be described below.

A function of the movement amount adjustment unit 34 and a process based on the function will be described below.

In the following description, in a case in which the first indicator 70 and the second indicator 80 are not distinguished from each other for expression, the first indicator 70 and the second indicator 80 are expressed as an “indicator S”.

Incidentally, the projector 100 can display an object image on the screen SC in addition to an image based on an input from the image I/F unit 12.

In the embodiment, the object image refers to an image of which a display position can be moved on the screen SC by a movement gesture (to be described below). The object image is, for example, a GUI that is provided by a function of the projector 100, a window based on the image data input from an external apparatus via the I/F unit 11, an image that is drawn with the second indicator 80 or the first indicator 70 by the operator. An image of which a display position can be moved by a movement gesture is equivalent to the object image.

Here, the size of the image projection region described above on the screen SC varies by a difference in a model of the projector 100, a separation distance between the screen SC and the projector 100, setting of the projector, and other factors, and thus is not constant.

In the projector 100 according to the embodiment, the object image can be moved in response to movement of the indicator S by bringing the object image into contact with the object image displayed in the image projection region with the indicator S and moving the indicator S in a predetermined direction while maintaining the contact state of the indicator S to the screen SC.

In a case in which the object image is moved according to the above-described method, there is the following problem. That is, for example, in a case in which a horizontal width of the image projection region is within a range reached with open arms by the operator, the operator can easily move an object image located at one end of the image projection region in the horizontal direction according to the above-described method to the other end of the image projection region. Conversely, in a case in which the horizontal width of the image projection region is considerably larger than the range reached with open arms by the operator and a case in which the operator moves an object image located at one end of the image projection region in the horizontal direction to the other end of the image projection region according to the above-described method, it is not easy for the operator to perform this operation because a situation in which the operator has to walk occurs.

Based on the above, the projector 100 performs the following process in regard to movement of an object image.

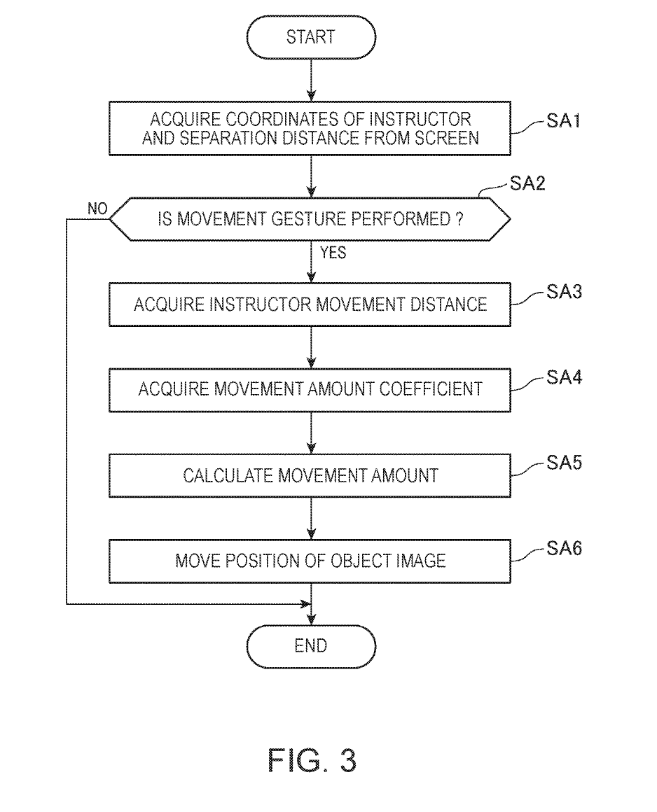

FIG. 3 is a flowchart illustrating an operation of the projector 100.

When a process of FIG. 3 starts, image data corresponding to an object image is loaded to the frame memory 41 under the control of the image processing unit 40 by the projection control unit 31 and the object image is displayed in the image projection region on the screen SC.

As illustrated in FIG. 3, in a case in which the first indicator 70 is located within a photographic range of the photographing unit 51, the detection unit 33 acquires the coordinates of the instruction position of the first indicator (hereinafter referred to as “first instruction position coordinates”) and the first separation distance information at a predetermined period based on an input from the coordinate calculation unit 55. Additionally, in a case in which the second indicator 80 is located within the photographic range of the photographing unit 51, the detection unit 33 acquires the coordinates of the instruction position of the second indicator 80 (hereinafter referred to as “second instruction position coordinates”) and the second separation distance information at a predetermined period (step SA1).

Subsequently, based on the information acquired in step SA1, the detection unit 33 determines whether a movement gesture is performed with the indicator S (step SA2). That is, based on the continuous first instruction position coordinates and first separation distance information acquired at the predetermined period in step SA1, the detection unit 33 determines whether the movement gesture is performed with the first indicator 70. Additionally, based on the continuous second instruction position coordinates and second separation distance information acquired at the predetermined period, the detection unit 33 determines whether the movement gesture is performed with the second indicator 80. Hereinafter, the process of step SA2 will be described in detail.

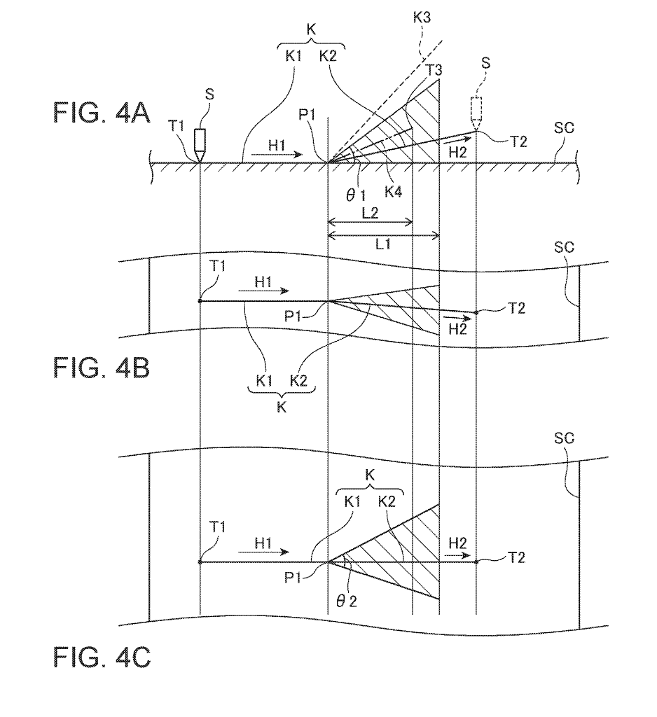

FIG. 4 is a diagram illustrating a movement gesture. FIG. 4(A) illustrates a trajectory of the instruction position of the indicator S when a movement gesture is performed in a case in which the screen SC is viewed toward the upper side along the surface of the screen SC. FIG. 4(B) illustrates a trajectory of the instruction position of the indicator S when the same movement gesture as the movement gesture illustrated in FIG. 4 (A) is performed in a case in which the screen SC is viewed along an optical axis of the projection optical system (an axis extending in a direction directed toward the screen SC in an obliquely low direction) in the setting state of the projector 100 illustrated in FIG. 1. FIG. 4(C) illustrates a trajectory of the instruction position of the indicator S when the same movement gesture as the movement gesture illustrated in FIG. 4(A) is performed in a case in which the screen SC is viewed from the front side.

The movement gesture is a gesture including a first movement in which the instruction position of the indicator S is moved in a first direction while coming into contact with the screen SC and a second movement in which the instruction position of the indicator S is moved in a second direction in a contactless state to the screen SC continuously from the first movement.

In FIG. 4, a trajectory K indicates a trajectory of the instruction position of the indicator S in a movement gesture in which T1 is set as a starting point and T2 is set as an ending point. In the trajectory K, a trajectory K1 indicates a trajectory of the instruction position of the indicator S moving in a first direction H1 in the first movement and a trajectory K2 indicates a trajectory of the instruction position of the indicator S moving in a second direction H2 in the second movement.

The second movement is subject to a requirement that the trajectory of the instruction position of the indicator S satisfies the following condition.

In the following description, a region in a 3-dimensional predetermined range (a region indicated by oblique lines in FIG. 4) in which an angle in a direction perpendicular to the surface of the screen SC spreads within a first angle (“θ1” in FIG. 4(A)) using a transition point (P1 in FIG. 4) at which the first movement transitions to the second movement as an origin in a virtual straight line extending in the first direction using the transition point as the origin and an angle in a direction parallel to the surface of the screen SC spreads within a second angle (“θ2” in FIG. 4(C)) is referred to as a “movable region”.

The size of the movable region is defined by a length (L1 in FIG. 4) of a virtual straight line extending in the first direction using the transition point as the origin.

The condition for determining the second movement is a condition that an angle in the direction perpendicular to the surface of the screen SC is within the first angle in the trajectory of the indicator S in which the movement point is the origin and the angle in the direction parallel to the surface of the screen SC is within the second angle. In a case in which the condition is not satisfied, the detection unit 33 does not determine the second movement. For example, in a trajectory K3 of the indicator S indicated by a dotted line in FIG. 4(A), the angle in the direction perpendicular to the surface of the screen SC exceeds the first angle (θ1). Therefore, the detection unit 33 does not determine the second movement in the trajectory K3.

In this way, in a case in which the trajectory of the indicator S is within a range of the movable region, the reason for determining the second movement is as follows.

That is, the reason is that the operator determines a gesture intentionally performed with an intention to move an object image in a mode to be described below as a movement gesture. That is, the gesture determined as the movement gesture is an operation in which the above-described first and second movements are rarely accidentally continuous. In a case in which the trajectory of the indicator S is within a range of the movable region, a gesture intentionally performed by the user can be determined as a movement gesture by determining the second movement. The gesture determined as the movement gesture implicates an operation performed when a physical paper medium is moved in a predetermined direction. The user easily images a work to be performed to determine the gesture as the movement gesture.

Meanwhile, instep SA2, in regard to the first indicator 70, the detection unit 33 detects a trajectory of the instruction position of the first indicator 70 on the basis of the first separation distance information and first instruction position coordinates based on information continuously input at a predetermined period. Specifically, the detection unit 33 plots the instruction position of the first indicator 70 continuous at a predetermined period in a rectangular coordinate system of a virtual 3-dimensional space in which a virtual axis extending in the horizontal direction in parallel to the surface of the screen SC is set as the x axis, a virtual axis extending in the vertical direction side by side with the surface of the screen SC is set as the y axis, and a virtual axis extending orthogonally to the surface of the screen SC is set as the z axis and detects a line connecting plotted points (hereinafter referred to as “a trajectory line”) as a trajectory of the instruction position of the first indicator 70. Subsequently, the detection unit 33 determines whether the trajectory line in the above-described coordinate system contains a line corresponding to the first movement and a line corresponding to the second movement continued to the line. In relation to determination of whether a predetermined line contained in the trajectory line is a line corresponding to the second movement, the detection unit 33 calculates a region corresponding to the movable region in the above-described coordinate system, determines whether the trajectory of the instruction position of the first indicator 70 corresponding to the predetermined line satisfies the above-described condition based on a positional relation between the calculated region and the predetermined line, and does not determine the predetermined line as the line corresponding to the second movement in a case in which the condition is not satisfied. In a case in which the detection unit 33 determines that the trajectory line in the above-described coordinate system contains the line corresponding to the first movement and the line corresponding to the second movement continued to the line, the detection unit 33 determines that the movement gesture is performed.

In step SA2, in regard to the second indicator 80, the detection unit 33 determines whether the movement gesture is performed according to the same method as the first indicator 70.

As illustrated in FIG. 3(A), in a case in which it is determined that the movement gesture is not performed (NO in step SA2), the movement amount adjustment unit 34 ends the process.

As illustrated in FIG. 3(A), in a case in which it is determined that the movement gesture is determined (YES instep SA2), the movement amount adjustment unit 34 performs the following process (step SA3).

That is, the movement amount adjustment unit 34 acquires an indicator movement distance which is a length of the indicator S in the first direction in the second movement.

Here, in a case in which the ending point of the trajectory of the instruction position of the indicator S by the second movement exceeds the movable region, in other words, a case in which the length of the trajectory of the instruction position of the indicator S in the first direction by the second movement exceeds the length of the movable region in the first direction, the movement amount adjustment unit 34 sets the length of the movable region in the first direction as a value of the indicator movement distance.

For example, in FIG. 4(A), the trajectory K2 is a trajectory of the instruction position of the indicator S in the second movement and the ending point T2 of the trajectory K2 exceeds the movable region. In this case, the movement amount adjustment unit 34 sets a length L1 of the movable distance in the first direction as a value of the indicator movement distance.

For example, in FIG. 4(A), an ending point T3 of a trajectory K4 indicated by a two-dot chain line is within the range of the movable region. In this case, the movement amount adjustment unit 34 sets a length L2 of the trajectory K4 in the first direction H1 as a value of the indicator movement distance.

In step SA3, the movement amount adjustment unit 34 calculates the value of the indicator movement distance based on the trajectory line in the above-described coordinate system.

Subsequently, the movement amount adjustment unit 34 acquires a movement amount coefficient (step SA4).

Here, in a predetermined storage region of the storage unit 60, a table in which the size of the image projection region (a combination of the length of the image projection region in the vertical direction and the length of the image projection region in the horizontal direction) is stored in association with the movement amount coefficient for each size is stored in advance. Information indicating the size of the image projection region detected at the time of calibration by the projection size measurement unit 32 is stored in a predetermined recording region of the storage unit 60. Instep SA4, the movement amount adjustment unit 34 acquires the size of the image projection region stored in the storage unit 60 and acquires the movement amount coefficient associated with the acquired size of the image projection region in the table with reference to the above-described table.

In the above-described table, as the size of the image projection region is larger, a value of the movement amount coefficient associated with the size of the image projection region is larger. A method of using the movement amount coefficient and a reason of a positive correlation between the size of the image projection region and the value of the movement amount coefficient will be described below.

A method of acquiring the movement amount coefficient is not limited to the above-described method. For example, a predetermined mathematical formula for calculating the movement amount coefficient is set in advance using the size of the image projection region. The movement amount adjustment unit 34 may calculate the movement amount coefficient using the mathematical formula.

Subsequently, the movement amount adjustment unit 34 calculates a movement amount based on the movement amount coefficient acquired in step SA4 (step SA5). Hereinafter, a process of step SA5 will be described in detail.

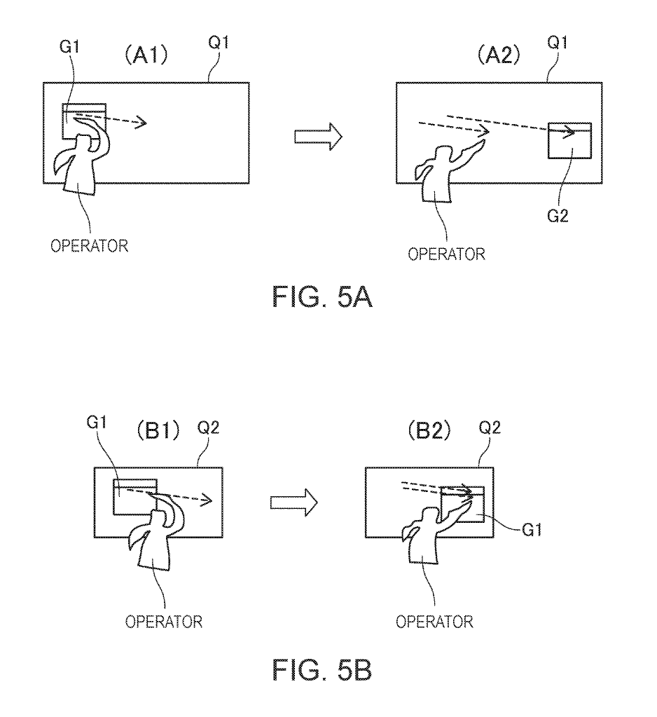

FIG. 5(A) is a diagram illustrating a movement amount. FIG. 5 (A1) is a diagram illustrating a form in which an object image G1 is displayed at the left end of an image projection region Q1 on the screen SC along with an operator. FIG. 5 (A2) is a diagram illustrating a form in which the operator performs a movement gesture in the state of FIG. 5 (A1) and the position of the object image G1 moved to the right end of the image projection region Q1 is displayed along with the operator.

Here, in a case in which the movement gesture (a first operation) is performed on one object image, the one object image is moved in a first direction related to the movement gesture by a movement amount (second movement amount) calculated by the movement amount adjustment unit 34 through a process to be described below.

That is, the movement amount is a separation distance between the position of an object image before movement and the position of the object image after movement in a case in which a movement gesture is performed to move the object image. In the example of FIG. 5(A), a separation distance between the position of the object image G1 illustrated in FIG. 5(A1) and the position of the object image G1 illustrated in FIG. 5(A2) is equivalent to the movement amount.

In step SA5, the movement amount adjustment unit 34 calculates the movement amount by the following formula based on the indicator movement distance acquired in step SA3 and the movement amount coefficient acquired in step SA4:

(formula) movement amount=indicator movement distance×movement amount coefficient.

Here, as described above, the size of the image projection region and the movement amount coefficient have a relation in which the size of the image projection region is larger, the corresponding movement amount coefficient is larger. Accordingly, when the indicator movement distance is the same, the value of the movement amount obtained in the foregoing formula is larger as the size of the image projection region is larger. Thus, the following effects are obtained.

FIG. 5(B1) is a diagram illustrating a form in which the object image G1 is displayed at the left end of an image projection region Q2 with a size smaller than the image projection region Q1 along with an operator. FIG. 5(B2) is a diagram illustrating a form which the operator performs a movement gesture in the same mode as that of FIG. 5(A) in the state of FIG. 5(B1) and the position of the object image G1 is moved to the right end of the image projection region Q2 along with the operator.

The movement gesture in the same mode means that in movement gestures, a first direction which is a direction of the trajectory of the instruction position of the indicator S in a first movement is the same as a second direction which is a direction of the trajectory of the instruction position of the indicator S in a second movement and indicator movement distances are the same.

As the size of the image projection region is larger, the movement amount coefficient is larger. Therefore, in a case in which a movement gesture is performed in the same mode, the movement amount is larger as the size of the image projection region is larger. For example, of a movement amount (second movement amount) of an object image when a movement gesture (first operation) is performed on an object image in a case of the size (second size) of the image projection region illustrated in FIG. 5(A) and a movement amount (first movement amount) of the object image when the movement gesture (first operation) is performed in the same mode in a case in which the size of the image projection region, as illustrated in FIG. 5(B), is a size (first size) smaller than the image projection region illustrated in FIG. 5(A), the movement amount (second movement amount) of a case in which the size of the projection image region is larger, as illustrated in FIG. 5(A) is larger. As a result, as apparent in comparison between FIGS. 5(A) and 5(B), the operator may perform a movement gesture in the same mode regardless of the size of the image projection region in a case in which the object image is moved from one end to another end of the image projection region. As a result, in a case in which the object image G1 is moved from one end to another end of the image projection region Q1, as in the example of FIG. 5(B), it is necessary to perform a work in association with walking in a method of the related art. However, a worker can perform a movement gesture to move the object image G1 instead of the work, and thus it is easy for the worker to perform a work (operation).

In continuous step SA6, the projection control unit 31 moves a loading position of the image data of the object image in the frame memory 41 by controlling the image processing unit 40 and moves a display position of the object image, which is a movement target through a movement gesture, in the image projection region by the movement amount calculated in step SA6 by the movement amount adjustment unit 34 in the first direction.

As a result of the process of step SA6, in response to the movement gesture, the position of the object image is moved by the movement amount corresponding to the size of the image projection region.

In step SA6, the projection control unit 31 may perform the following process in a case in which the object image is an image based on image data supplied from an external apparatus. That is, information indicating the coordinates of the object image after movement in association with the movement gesture is transmitted to the external apparatus. For example, the external apparatus updates information for managing the display position of the object image based on the received information and sets the information to a value corresponding to an actual display position of the object image.

As described above, the projector 100 according to the embodiment includes: the projection unit 20 that projects the projection image including the object image (the first object) to the screen SC (the projection surface); the projection size measurement unit 32 that measures the size of the image projection region (the region to which the projection image is projected; the detection unit 33 that detects an operation of the indicator S (the first indicator 70 or the second indicator 80) on the screen SC; and the movement amount adjustment unit 34 that causes a movement amount of the object image to differ in accordance with the size of the image projection region in a case in which the operation of the indicator S detected by the detection unit 33 is a movement gesture (an operation of moving the object image).

In this configuration, to correspond to non-constancy of the size of the image projection region, the projector 100 can set a movement amount at the time of moving the position of the object image based on the movement gesture as a value corresponding to the size of the image projection region.

According to the embodiment, of a movement amount (first movement amount) of the object image when an operation (first operation) of the indicator S is performed in a case in which the size of the image projection region is a first size and a movement amount (second movement amount) when the operation of the indicator S (the first operation which is the same operation as the operation performed in the case of the first size) is performed in a case in which the size of the image projection region is a second size larger than the first size, the movement amount adjustment unit 34 causes the movement amount (the second movement amount) of the object image to be larger in the case of the second size.

The movement amount adjustment unit 34 causes the movement amount of the object image to be larger in a case in which the same operation of the indicator S is performed as the size of the image projection region is larger.

In this configuration, as the size of the image projection region is larger, the movement amount of the object image at the time of performing the movement gesture in the same mode to be larger. Thus, it is easy for the operator to move the object image.

According to the embodiment, the movement gesture is an operation continuously transitioning from a state in which the indicator S comes into contact with the screen SC and moves to a state in which the indicator S moves contactlessly.

The movement amount adjustment unit 34 calculates the movement amount of the object image by multiplying a movement distance of the indicator S (an indicator movement distance) after the transition of the indicator S to the contactless state to the screen SC by a coefficient according to the size of the image projection region (a movement amount coefficient).

In this configuration, the operator can determine a gesture intentionally performed with an intention to move an object image as a movement gesture. The gesture determined as the movement gesture implicates an operation performed when a physical paper medium is moved in a predetermined direction. The user easily images a work to be performed to determine the gesture as the movement gesture. The movement amount adjustment unit 34 can set the value of the movement amount as an appropriate value according to the size of the image projection region using the movement amount coefficient.

According to the embodiment, the projection size measurement unit 32 causes the projection unit 20 to project a specific pattern image (a specific pattern image) to the screen SC, causes the photographing unit 51 to photograph the screen SC to which the specific pattern image is projected, and measures the size of the image projection region based on a photographing result by the photographing unit 51.

In this configuration, a work of the user is not necessary and convenience for the user is improved in the measurement of the size of the image projection region.

The above-described embodiment and modification examples are merely examples of specific aspects to which the invention is applied and do not limit the invention. The invention can also be applied as other aspects. For example, the first indicator 70 is not limited to the pen-type indicator and the second indicator 80 is not limited to a finger of the operator. For example, a laser pointer, an instruction rod, or the like may be used as the first indicator 70. The shape or size of the first indicator 70 is not limited.

In the foregoing embodiment, the position detection unit 50 causes the photographing unit 51 to photograph the screen SC and specifies the positions of the first indicator 70 and the second indicator 80, but the invention is not limited thereto. For example, the photographing unit 51 is not limited to the configuration in which the photographing unit 51 is installed in the body of the projector 100 and photographs a projection direction of the projection optical system 23. The photographing unit 51 may be disposed as a separate body from the body of the projector 100 and the photographing unit 51 may perform photographing on a lateral side or a front surface of the screen SC.

In the foregoing embodiment, the mode has been described in which a user performs an operation on the screen SC to which an image is projected (displayed) from the front projection type projector 100, using the first indicator 70 and the second indicator 80. In addition, a mode in which an instruction operation is performed on a display screen displayed by a display apparatus other than the projector 100 may be used. As the display apparatus other than the projector 100, a rear projection (back projection) type projector, a liquid crystal display, or an organic electro-luminescence (EL) display can be used. As the display apparatus, a plasma display, a cathode ray tube (CRT) display, a surface-conduction electron-emitter display (SED), or the like can be used.

In the foregoing embodiment, the configuration has been described in which the synchronization signal is transmitted to the first indicator 70 using the infrared signal emitted by the transmission unit 52 from the projector 100 to the first indicator 70, but the synchronization signal is not limited to the infrared signal. For example, the synchronization signal may be transmitted through radio wave communication or ultrasonic radio communication. This configuration can be realized by installing the transmission unit 52 transmitting a signal through radio wave communication or ultrasonic radio communication in the projector 100 and installing the same reception unit in the first indicator 70.

In the foregoing embodiment, the example has been described in which the three transmissive liquid crystal panels corresponding the colors of RGB are used as the light modulation device 22 modulating light emitted by the light source, but the invention is not limited thereto. For example, three reflective liquid crystal panels may be configured to be used or a scheme in which one liquid crystal panel and a color wheel are combined may be used. A scheme in which three digital mirror devices (DMDs) are used or a DMD scheme in which one digital mirror device and a color wheel are combined may be configured. In a case in which only one liquid crystal panel or DMD is used as the light modulation device, a member equivalent to a combination optical system such as a cross dichroic prism is not necessary. A light modulation device can also be adopted as well as the liquid crystal panel and the DMD as long as the light modulation device can modulate light emitted by the light source.

The functional units of the projector 100 illustrated in FIG. 2 illustrate functional configurations and specific mounting forms are not particularly limited. That is, it is not necessary to mount hardware individually corresponding to each functional unit and functions of a plurality of functional units can, of course, also be realized when one processor executes a program. Some of the functions realized by software in the foregoing embodiment maybe realized by hardware or some of the functions realized by hardware may be realized by software. In addition, a specific detailed configuration of each of the other units of the projector 100 can also be changed arbitrarily in the scope of the invention without departing from the gist of the invention.

### REFERENCE SIGNS LIST

20 projection unit
32 projection size measurement unit
33 detection unit
34 movement amount adjustment unit
51 photographing unit
100 projector
70 first indicator (indicator)
80 second indicator (indicator)

1. A projector comprising:
a projection unit that projects a projection image including a first object to a projection surface;
a projection size measurement unit that measures a size of a region to which the projection image is projected;
a detection unit that detects an operation of an indicator on the projection surface; and
a movement amount adjustment unit that causes a movement amount of the first object to differ in accordance with the size of the region to which the projection image is projected in a case in which the operation of the indicator detected by the detection unit is an operation of moving the first object.

2. The projector according to claim 1,
wherein of a first movement amount of the first object when a first operation of moving the first object is performed in a case in which the size of the region to which the projection image is projected is a first size and a second movement amount of the first object when the first operation is performed in a case in which the size of the region to which the projection image is projected is a second size larger than the first size, the movement amount adjustment unit causes the second movement amount to be larger.

3. The projector according to claim 2,
wherein the movement amount adjustment unit causes the movement amount of the first object to be larger in a case in which the same operation of the indicator is performed as the size of the region to which the projection image is projected is larger.

4. The projector according to claim 1,
wherein the operation of moving the first object is an operation continuously transitioning from a state in which the indicator comes into contact with the projection surface and moves to a state in which the indicator moves without contact with the projection surface, and
wherein the movement amount adjustment unit calculates the movement amount of the first object by multiplying a movement distance of the indicator after the transition of the indicator to the state in which the indicator moves without contact with the projection surface by a coefficient according to the size of the region to which the projection image is projected.

5. The projector according to any one of claims 1, further comprising:
a photographing unit that photographs the projection surface,
wherein the projection size measurement unit causes the projection unit to project a specific pattern image to the projection surface, causes the photographing unit to photograph the projection surface to which the pattern image is projected, and measures the size of the region to which the projection image is projected based on a photographing result by the photographing unit.

6. A method of controlling a projector including a projection unit that projects a projection image including a first object to a projection surface, the method comprising:
measuring a size of a region to which the projection image is projected;
detecting an operation of an indicator on the projection surface; and
causing a movement amount of the first object to differ in accordance with the size of the region to which the projection image is projected in a case in which the detected operation of the indicator is an operation of moving the first object.
